(19) United States
(12) Patent Application Publication
(10) Pub. No.: US 2004/0221726 A1
(43) Pub. Date: Nov. 11, 2004

(54) Bread maker

(75) Inventors: Jae-Ryong Park, Suwon city (KR); Yong-Hyun Kwon, Suwon city (KR); Chul Kim, Anyang city (KR); Tae-Uk Lee, Suwon city (KR); Han-Jun Sung, Suwon city (KR); Jang-Woo Lee, Suwon city (KR); Dong-Bin Lim, Suwon city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/714,610

(22) Filed: Nov. 18, 2003

(30) Foreign Application Priority Data
May 7, 2003 (KR) 2003-29123

(51) Int. Cl. A23L 1/00

(52) U.S. Cl. 99/348

(57) ABSTRACT

A bread maker including a main body, an oven accommodated in the main body, a baking tray placed inside the oven and formed with a profile groove, and a profile combined in the profile groove of the baking tray, the profile groove of the baking tray having a plurality of breakaway-prevention protrusions formed at edges thereof, to prevent the profile from from breaking away from the profile groove. With this configuration, the bread maker including a molded baking tray with the profile groove is provided, so that work efficiency and productivity are increased.

### CROSS-REFERENCE TO RELATED APPLICATION

This application claims the benefit of Korean Patent Application No. 2003-29213, filed May 7, 2003, in the Korean Intellectual Property Office, the disclosure of which is incorporated herein by reference.

### BACKGROUND OF THE INVENTION

1. Field of the Invention

The present invention relates to a bread maker, and more particularly, to a bread maker with an improved combination structure between a baking tray and a profile.

2. Description of the Related Art

Conventionally, a bread maker has been developed so as to allow a user to easily and conveniently make bread, which automatically performs a chain of baking processes.

A conventional bread maker typically comprises a main body, an oven accommodated in the main body, a baking tray 2 formed with a profile groove 4 and placed inside the oven, and a profile 6 having a cylindrical shape and combined to the profile groove.

As shown in FIGS. 1A and 1B, in a conventional bread maker, a baking tray is formed with a profile groove 4 having a circular cross-section with an undercut. However, to make the shape of the profile groove 4 by molding is difficult. Therefore, in the conventional bread maker, the baking tray 2 is first molded without the profile groove 4, and then the profile groove 4 is separately formed by machining. Thus, work efficiency and productivity are decreased, so that not only a manufacturing process of the conventional bread maker is delayed but also a cost of the baking tray is increased, thereby making the conventional bread maker less price competitive.

### SUMMARY OF THE INVENTION

Accordingly, it is an aspect of the present invention to provide a bread maker having an improved structure of a profile groove formed in a baking tray, so that a profile is securely and compressively supported.

Additional aspects and/or advantages of the invention will be set forth in part in the description which follows and, in part, will be obvious form the description, or may be learned by practice of the invention.

The above and/or other aspects of the present invention are achieved by providing a bread maker comprising a main body, an oven accommodated in the main body, a baking tray placed inside the oven and formed with a profile groove, and a profile combined in the profile groove of the baking tray, the profile groove of the baking tray having a plurality of breakaway-prevention protrusions formed at edges thereof to prevent the profile from breaking away therefrom.

According to an aspect, the breakaway-prevention protrusions of the profile groove securely support an outer circumference of the profile.

According to an aspect, the breakaway-prevention protrusions of the profile groove are plurally provided at upper and lower edges of the profile groove.

According to an aspect, the breakaway-prevention protrusions are formed on the profile groove by press-forming.

### BRIEF DESCRIPTION OF THE DRAWINGS

These and/or other aspects and advantages of the present invention will become apparent and more readily appreciated from the following description of the embodiment, taken in conjunction with the accompany drawings of which:

FIG. 1A is a sectional view illustrating a combination structure between a baking tray and a profile in a conventional bread maker;

FIG. 1B is a partial sectional view of area A of FIG. 1A.

FIG. 2 is a perspective view of a bread maker according to an embodiment of the present invention;

FIG. 3 is a perspective view of the bread maker of FIG. 2, with a door thereof in an open position;

FIG. 4 is an exploded perspective view of a baking tray and a profile in the bread maker of FIG. 2;

FIG. 5 is a perspective view of the baking tray and the profile of FIG. 4;

FIG. 6A is a sectional views illustrating a combination structure between the baking tray and the profile, taken along line VI-VI in FIG. 5; and

FIG. 6B is a partial sectional view of area B of FIG. 6A.

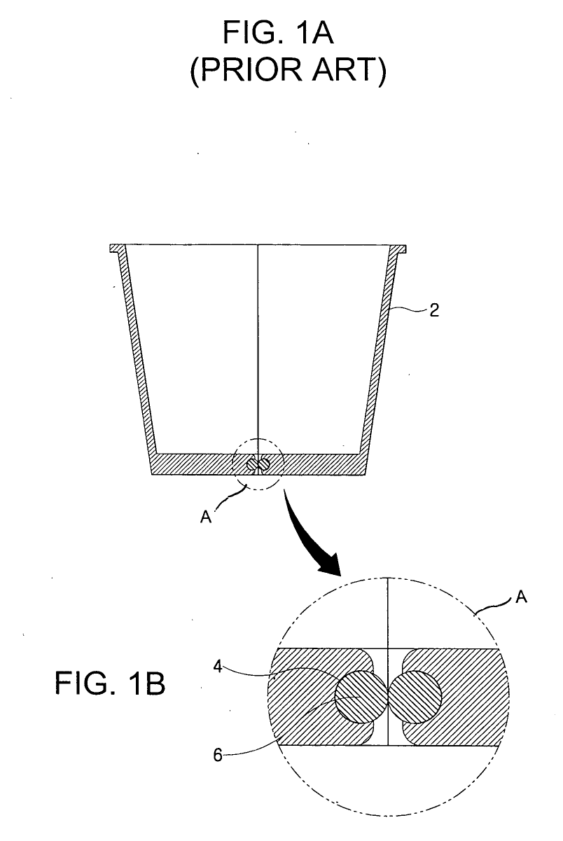

### DETAILED DESCRIPTION OF THE PREFERRED EMBODIMENT

Reference will now be made in detail to the embodiment of the present invention, examples of which are illustrated in the accompanying drawings, wherein like reference numerals refer to like elements throughout. The embodiment is described below in order to explain the present invention by referring to the figures.

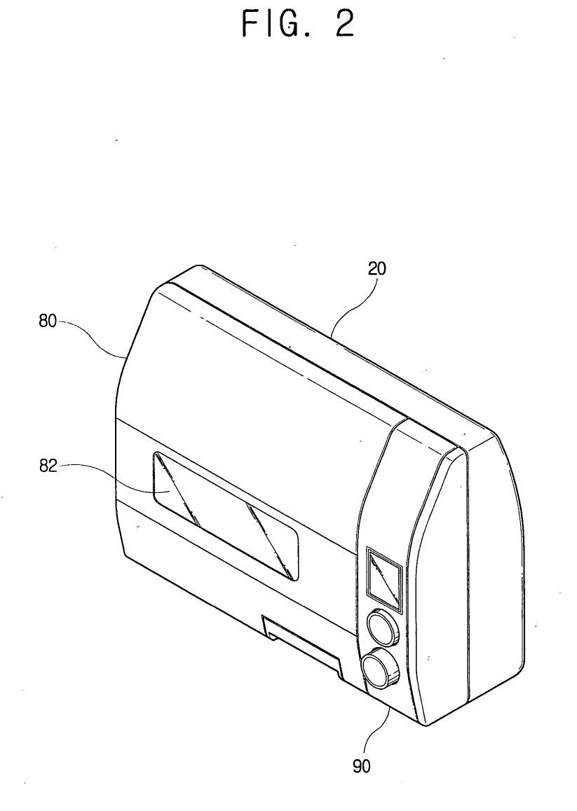

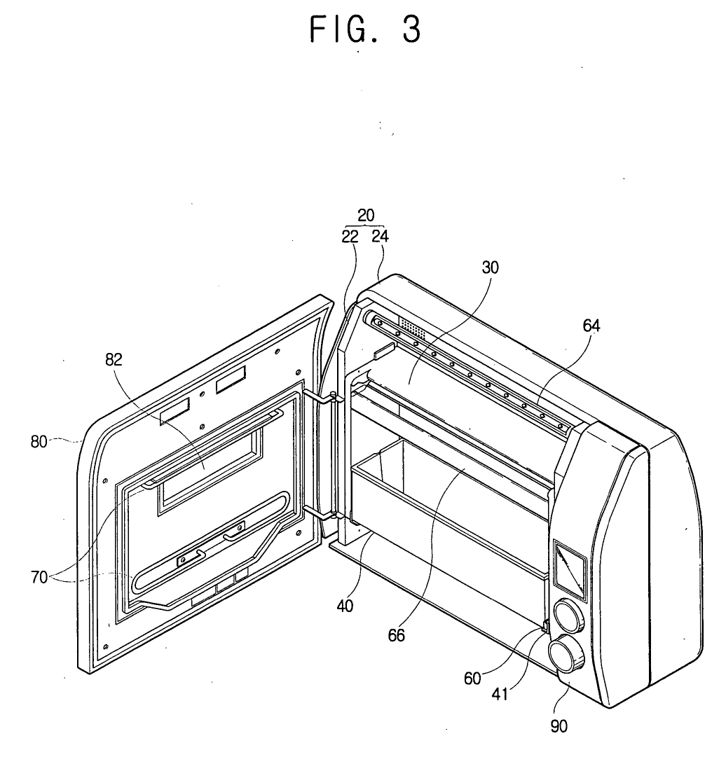

As shown in FIGS. 2 and 3, a bread maker according to an embodiment of the present invention comprises a main body 20, an oven 30 accommodated in the main body 20, a baking tray 40 placed inside the oven 30, a plurality of heaters 70 to heat an inside of the oven 30, and a door 80 provided in a front of the main body 20 so as to open and to close the oven 30.

The main body 20 includes a frame 22 forming an oven compartment in which the oven 30 is accommodated, a frame cover 24 covering an outside of the frame 22, and a control panel 90 provided in a front side of the main body 20 and allowing a user to control the bread maker and to view an operating state of the bread maker.

An upper kneading drum 64 and a lower kneading drum (not shown) are provided at upper and lower sides of the oven 30 such that the upper kneading drum 64 and the lower kneading drum and are disposed in parallel and rotate alternately in clockwise and counterclockwise directions. On the upper kneading drum 64 and the lower kneading drum are wound opposite ends of a mixing bag (not shown) filled with ingredients for bread, respectively. Between the upper kneading drum 64 and the lower kneading drum is provided a pair of dough-blocking members 66 to prevent dough being kneaded in the mixing bag from moving toward the upper kneading drum 64.

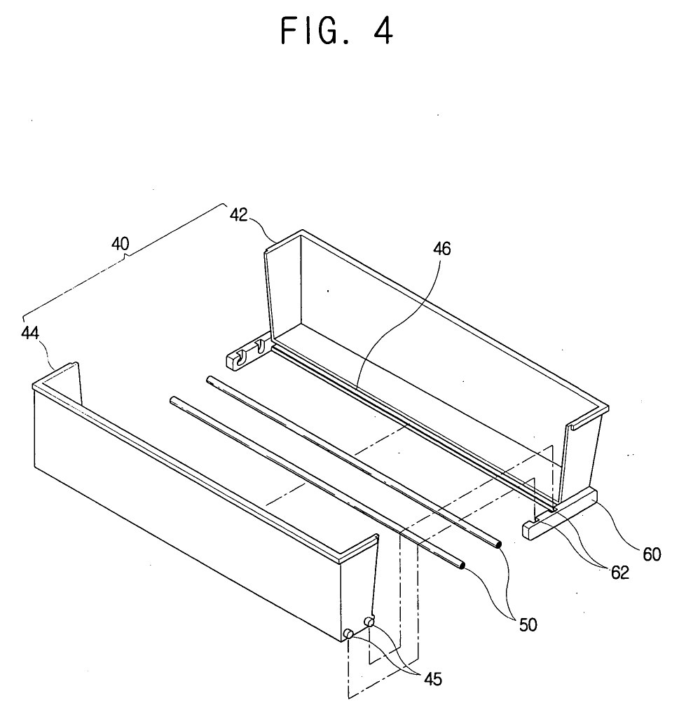

The baking tray 40 is disposed between the upper kneading drum 64 and the lower kneading drum, and is in a box like shape with a top opening to contain completely kneaded dough. Further, the baking tray 40 may be made of aluminum or steel which has a good heat-resisting property. In lower opposite sides of the baking tray 40 are provided tray holders 60, respectively. As shown in FIG. 4, the tray holders 60 are detachably sliding-combined with tray rails 41 (see FIG. 3) provided in inner opposite sides of the oven 30, respectively.

The plurality of heaters 70 are, respectively, disposed in upper and lower parts of the door 80 and in upper and lower parts of the oven 30, thereby heating the inside of the oven 30.

The door 80 is rotatably combined to the main body 20 so as to selectively open and close a front opening of the oven 30.

Further, the door 60 comprises a window glass 82 allowing a user to view the inside of the oven 30 therethrough.

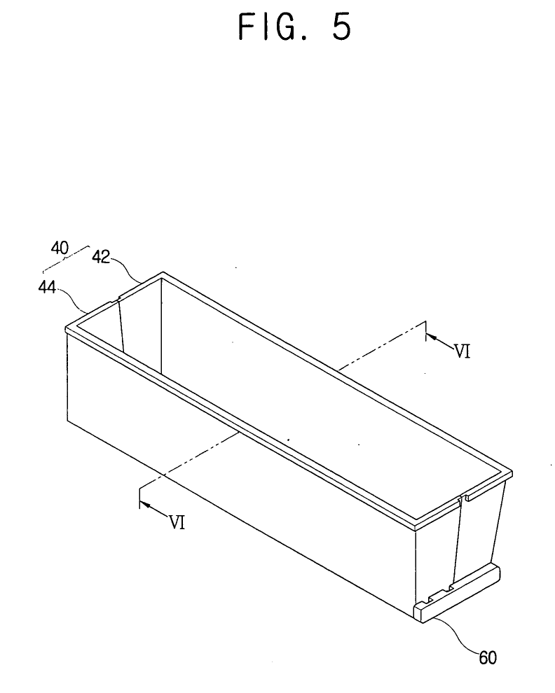

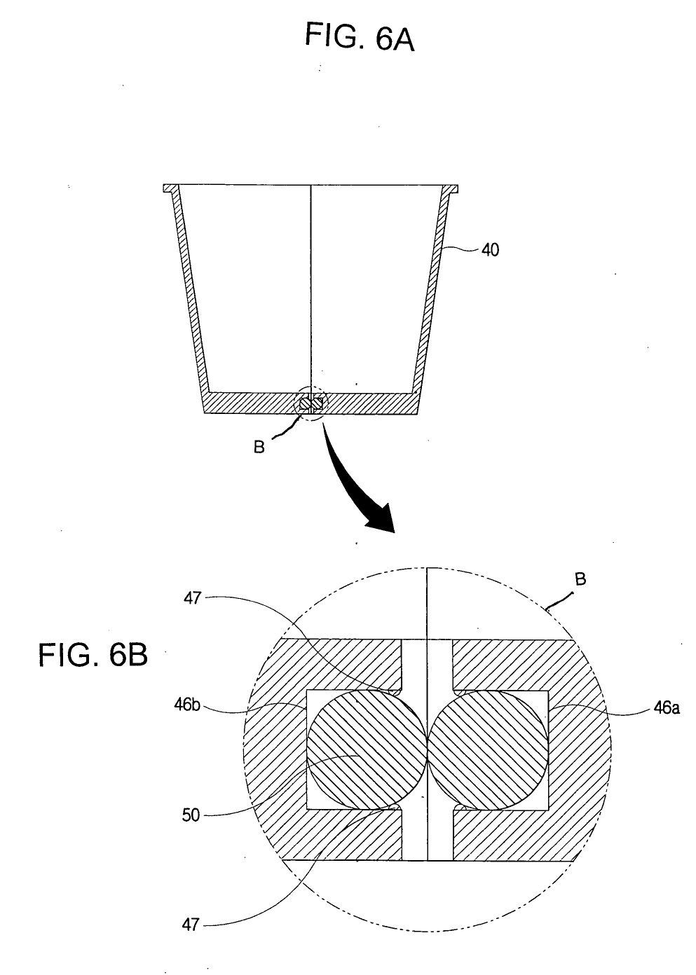

As shown in FIGS. 4 through 6B, the tray 40 comprises a stationary tray 42 having a first profile groove portion 46a provided in a lower section along a lengthwise direction thereof, and a rotatable tray 44 having a second profile groove portion 46b opposite to the first profile groove portion 46a of the stationary tray 42, such that the stationary tray 42 and the rotatable tray 44 are combined to each other to form a box shape with the top opening. The first and second groove portions combine to form a profile groove 46. One or more profiles 50 are compressively fit into a space formed by the first and second profile groove portions 46a and 46b of the stationary and rotatable trays 42 and 44.

In lower opposite sides of the stationary tray 42 are, respectively, provided the tray holders 60 which are used in holding the rotatable tray 44 and allowing the rotatable tray 44 to selectively rotate thereon. In lower opposite sides of the rotatable tray 44 are protruded a plurality of projections 45 to rotatably combine to the tray holders 60.

Each of the tray holders 60 is formed with a plurality of guide grooves 62 corresponding to the plurality of projections 45 of the rotatable tray 44.

The respective first and second profile groove portions 46a and 46b of the stationary and rotatable trays 42 and 44, each have a rectangular cross-section, and are provided with a plurality of breakaway-prevention protrusions 47 securely and compressively supporting partial outer surfaces of the profiles 50 so as to prevent the profiles 50 corresponding to the first and second profile groove portions 46a and 46b from breaking away therefrom.

The breakaway-prevention protrusions 47 are incorporated with the respective stationary and rotatable trays 42 and 44 by molding, and are plurally provided in inner upper and inner lower edges of each of the first and second profile groove portions 46a and 46b. However, the breakaway-prevention protrusions 47 may vary in a placing position, a number, a size, and a shape thereof as necessary within ranges to securely and compressively support each of the profiles 50.

The breakaway-prevention protrusions 47 may be integrally formed on the first and second profile groove portions 46a and 46b by a press.

As is described above, a bread maker including a molded baking tray with a profile groove is provided, so that work efficiency and productivity are increased. Thus, manufacturing cost of the baking tray is reduced, thereby allowing the bread maker to have an advantage in price competitiveness.

Further, a bread maker in which a profile is effectively prevented from a breakaway from a profile groove is provided.

Although an embodiment of the present invention has been shown and described, it will be appreciated by those skilled in the art that changes may be made in the embodiment without departing from the principles and spirit of the invention, the scope of which is defined in the appended claims and their equivalents.

What is claimed is:

1. A bread maker, comprising:
a main body;
an oven accommodated in the main body;
a baking tray placed inside the oven and formed with a profile groove; and
a profile combined in the profile groove of the baking tray, the profile groove of the baking tray having a plurality of breakaway-prevention protrusions formed at edges thereof to prevent the profile from breaking away from the profile groove.

2. The bread maker according to claim 1, wherein the breakaway-prevention protrusions of the profile groove securely support an outer circumference of the profile.

3. The bread maker according to claim 1, wherein the breakaway-prevention protrusions of the profile groove are plurally provided in upper and lower edges of the profile groove.

4. The bread maker according to claim 2, wherein the breakaway-prevention protrusions of the profile groove are plurally provided in upper and lower edges of the profile groove.

5. The bread maker according to claim 1, wherein the breakaway-prevention protrusions are formed on the profile groove by press-forming.

6. The bread maker according to claim 3, wherein the breakaway-prevention protrusions are formed on the profile groove by press-forming.

7. A bread maker having a main body, comprising:
a baking tray placed in the main body and having a profile groove;
a plurality of protrusions formed at edges of the profile groove; and
one or more profiles combined in the profile groove of the baking tray such that the plurality of protrusions prevents the one of more profiles from breaking away from the profile groove.

8. The bread maker according to claim 7, wherein each of the profiles is cylindrical in a shape thereof.

9. The bread maker according to claim 7, wherein the baking tray comprises:
a stationary tray; and
a moveable tray moveably coupled to the stationary tray.

10. The bread maker according to claim 9, wherein:
the stationary tray comprises:
a first profile groove portion provided in a lower section thereof and along a lengthwise direction thereof; and
the moveable tray comprises:
a second profile groove portion provided opposite to the first profile groove portion of the stationary tray such that the stationary tray and the moveable tray are combinable to each other.

11. The bread maker according to claim 10, wherein the one of more profiles are compressively fit into a space formed by the first and second profile groove portions.

12. The bread maker according to claim 10, wherein the first and second profile groove portions of the stationary and moveable trays are provided with the plurality of protrusions.

13. The bread maker according to claim 12, wherein the first and second profile groove portions have rectangular cross-sections,

14. The bread maker according to claim 12, wherein the plurality of protrusions are a plurality of breakaway-prevention protrusions to securely and compressively support partial outer surfaces of each of the one or more profiles so as to prevent the one or more profiles corresponding to the first and second profile grooves portions from breaking away therefrom.

15. The bread maker according to claim 14, wherein the breakaway-prevention protrusions are incorporated with the stationary and moveable trays by molding, and are plurally provided in inner upper and inner lower edges of each of the first and second profile grooves portions.

16. The bread maker according to claim 14, wherein the breakaway-prevention protrusions are integrally formed on the first and second profile groove portions.

17. The bread maker according to claim 7, wherein the plurality of protrusions securely support outer circumferences of the one or more profile.

18. The bread maker according to claim 7, wherein the plurality of protrusions are provided in upper and lower edges of the profile groove.

19. The bread maker according to claim 17, wherein the plurality of protrusions are provided in upper and lower edges of the profile groove.

20. The bread maker according to claim 7, wherein the plurality of protrusions are press-formed on the profile groove.

21. The bread maker according to claim 19, wherein the plurality of protrusions are press-formed on the profile groove.
